(19) United States
(12) Patent Application Publication
(10) Pub. No.: US 2025/0245053 A1
(43) Pub. Date: Jul. 31, 2025

(54) MANAGING INFERENCE MODEL WORKLOAD PERFORMANCE

(71) Applicant: Dell Products L.P., Round Rock, TX (US)

(72) Inventors: RIZWAN ALI, Cedar Park, TX (US); DHARMESH M. PATEL, Round Rock, TX (US); RAVIKANTH CHAGANTI, Bangalore (IN)

(21) Appl. No.: 18/426,953

(22) Filed: Jan. 30, 2024

(51) Int. Cl. G06F 9/50

(52) U.S. Cl. CPC G06F 9/5038; G06F 9/505

(57) ABSTRACT

Methods and systems for managing performance of workloads by compute resources are disclosed. A workload may be performed by a portion of the compute resources in order to facilitate operation of an inference model. The workload type may be identified based on a lifecycle phase of the inference model, and the workload type may be used to obtain a resource consumption profile for the workload. Using the resource consumption profile, target compute resources usable to complete performance of the workload timely may be identified. Performance of the workload may be initiated using the target compute resources to obtain a workload result. A computer-implemented service may be provided using the workload result.

### FIELD

Embodiments disclosed herein relate generally to managing workload performance. More particularly, embodiments disclosed herein relate to systems and methods to manage performance of inference model workloads by compute resources.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a data flow diagram illustrating examples of lifecycle phases of inference models in accordance with an embodiment.

FIG. 2B shows a data flow diagram illustrating an example of managing workloads in accordance with an embodiment.

FIG. 3 shows a flow diagram illustrating a method for managing performance of workloads in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing performance of workloads by compute resources. The workloads may include inference model workloads, which may be performed to facilitate operation of the inference models. For example, the workloads may be performed in order to generate, maintain, and/or implement the inference models to provide computer-implemented services to downstream consumers (e.g., inferencing services).

The workloads may be performed by a network of data processing systems, such as a computing system. The data processing systems may include different quantities and/or types of compute resources with varying performance capabilities, and the compute resources may be operably connected (e.g., interconnected) via a complex network of connection paths with varying speeds and bandwidth. The computing system may include a limited amount of compute resources.

To perform a workload, the workload may be assigned to (and executed by) a portion of the compute resources. The compute resources may be consumed over a period of time until the workload has completed, and during this time, the portion of the compute resources may not be available to perform other workloads. This may present a problem when large volumes of workloads are to be performed by a limited amount of compute resources. For example, if a workload is not completed timely, then the provision of the computer-implemented services may be subject to disruptions and/or reductions in quality.

Therefore, in order to manage performance of large volumes of workloads on a complex and limited system of compute resources, resource consumption over time may be predicted for the workloads and the workloads may be scheduled to the computing system accordingly. To predict the resource consumption over time for a workload, the workload may be identified and classified by workload type. The workload type may be identified based on a lifecycle phase of an inference model lifecycle, during which associated workload types may consume a predictable quantity (and type) of compute resources. Using the predicted resource consumption over time, target resources most likely to perform the workload timely and efficiently may be identified.

By doing so, embodiments disclosed herein may provide a system managing performance of inference model workloads based on the inference model lifecycle. The performance of the inference model workloads may be managed in a manner that may increase the likelihood timely performance of the inference model workloads as well as efficient use of the compute resources over time.

In an embodiment, a method for managing performance of workloads by compute resources is provided. The method may include: identifying a new workload of the workloads to be performed to facilitate operation of an inference model; identifying a type of the new workload based on a lifecycle phase of the inference model; obtaining a resource consumption profile for the new workload based on the type of the new workload; identifying, based at least on the resource consumption profile, target compute resources of the compute resources to perform the new workload; initiating performance, using the target compute resources, of the new workload to obtain a new workload result; and, initiating provision of a computer-implemented service using the new workload result.

The new workload may include tasks relating to managing the inference model while the inference model is in the lifecycle phase. The resource consumption profile may specify predicted quantities of the compute resources that will be consumed to perform each task of the tasks. The predicted quantities of the compute resources may be specified for durations of time over which the tasks will be performed.

The method may further include screening, based on the resource consumption profile, the compute resources to identify a subset of the compute resources, the subset including a quantity of the compute resources sufficient for the new workload to be performed timely.

Identifying the target compute resources may include, for the subset of the compute resources: identifying at least one workload of the workloads assigned to the subset for performance; identifying a second resource consumption profile for the at least one workload; and, identifying a quantity of available compute resources of the subset based on the second resource consumption profile.

In an instance of the identifying where the quantity of the available compute resources is sufficient to perform at least a portion of the new workload timely, the method may include qualifying the subset to perform the new workload.

The quantity of the available compute resources may be available based on a time series that is usable to identify future periods of time when the subset is able to perform the new workload timely.

The lifecycle phase of the inference model may be one phase of a group of phases consisting of: training of the inference model; inferencing using the inference model; fine-tuning of the inference model; and, retraining of the inference model.

A non-transitory media may include instructions that when executed by a processor cause the computer-implemented method to be performed.

A data processing system may include the non-transitory media and a processor, and may perform the computer-implemented method when the computer instructions are executed by the processor.

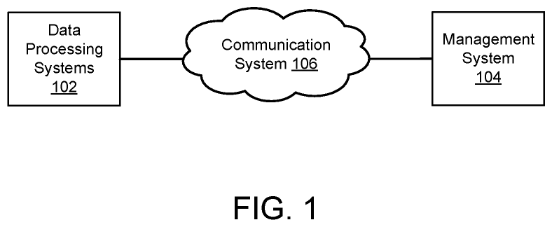

Turning to FIG. 1, a block diagram illustrating a system in accordance with an embodiment is shown. The (distributed) system shown in FIG. 1 may provide computer-implemented services. The computer-implemented services may include any type or quantity of services including, for example, data services (e.g., data storage, access and/or control services), communication services (e.g., instant messaging services, video-conferencing services), computing services (e.g., compute infrastructure services, workload management services), artificial intelligence (AI) services (e.g., inferencing services), and/or any other type of service that may be implemented with a computing device.

The computer-implemented services may be provided by one or more components of the system of FIG. 1. The computer-implemented services may be provided by, for example, data processing systems 102, management system 104, and/or any other type of devices (not shown in FIG. 1). A portion of the computer-implemented services may be provided, in part, using inference models (e.g., AI models). For example, the inference models may generate inferences usable by downstream consumers (not shown) who may provide computer-implemented services. The downstream consumers may use the inferences in order to improve decision-making, to automate processes, etc. The downstream consumers may rely on the timely supply and quality (e.g., accuracy) of the inferences in order to provide desired computer-implemented services. Therefore, a disruption to the supply of and/or reductions in quality of the inferences may negatively impact the downstream consumers and/or provision of the desired computer-implemented services.

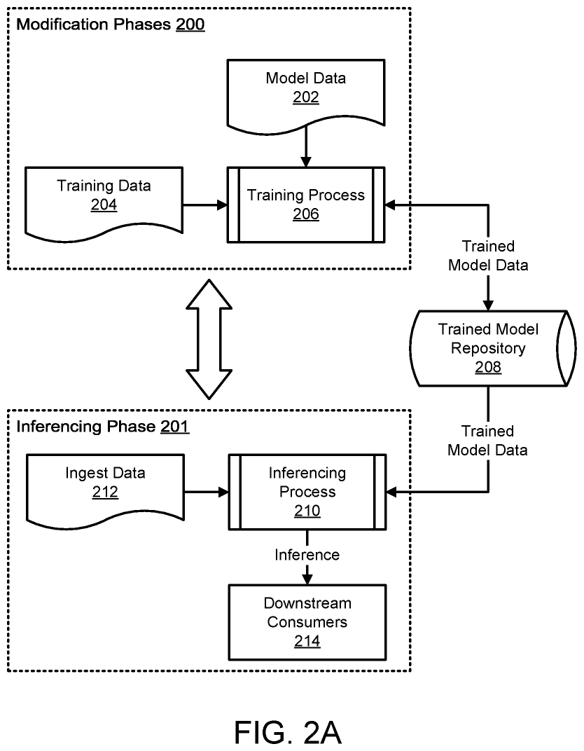

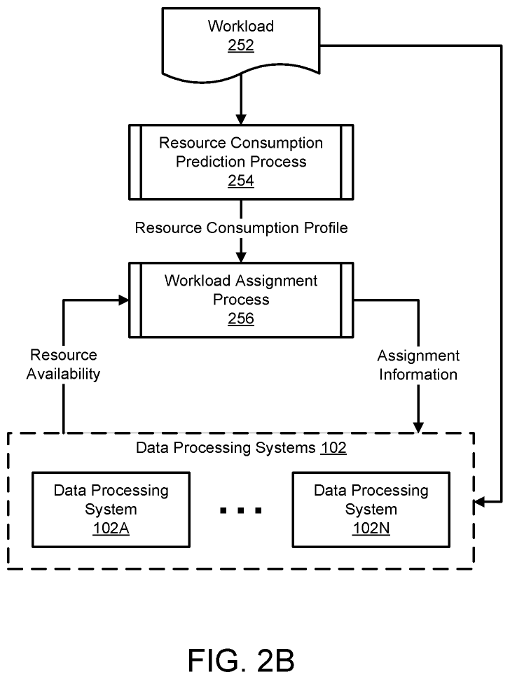

To provide reliable (e.g., desired quality, timely) computer-implemented services, an inference model may move through various phases of an inference model lifecycle. For example, the inference model may be generated (e.g., during a “training phase” of the inference model lifecycle), implemented (e.g., during an “inferencing phase” of the inference model lifecycle), maintained (e.g., during a “retraining phase” or a “fine-tuning phase” of the inference model lifecycle), and/or may go through other operations corresponding to any number of phases. During each phase of the inference model lifecycle, different types of workloads (e.g., computational tasks, processes, data transactions) may be performed to generate, implement, and/or maintain the inference model. Refer to the discussion of FIG. 2A for more information regarding lifecycle phases of inference models. The workloads (e.g., inference model workloads) may be performed by compute resources of a (distributed) computing system.

Data processing systems 102 may provide a portion of compute resources for performing any number and/or type of inference model workloads. Data processing systems 102 may include any number and/or type of data processing systems (e.g., computing devices). Each of data processing systems 102 may include any quantity and/or type of hardware components (e.g., processors, memory modules, storage devices, communications devices) that may support execution of any number and types of software components (e.g., applications). For example, some data processing systems (e.g., of 102) may include different types of processors, different quantities of memory and/or storage, etc. compared to other data processing systems (e.g., of 102). The compute resources may include, for example, infrastructure elements (e.g., the components of data processing systems 102) and/or other elements (e.g., electrical power used for facilitating operation of data processing systems 102).

Data processing systems 102 may be connected to one another via a network (e.g., a local area network). Any number of data processing systems 102 may be partitioned and treated as separate systems (e.g., clusters). For example, each cluster may include any number of nodes (e.g., a data processing system of data processing systems 102), and each node may include any number of processors (e.g., central processing unit (CPU), graphics processing unit (GPU), tensor processing unit (TPU)) usable to perform a portion of a workload. The network architecture that operably connects data processing systems 102 may be designed for high-performance computing services (e.g., high-speed, low-latency networking). Data processing systems 102 may form a computing system that includes a network of limited compute resources. The computing system provided by data processing systems 102 may be used, in part, to perform workloads that facilitate operation of inference models.

Different types of workloads may be more efficiently performed using different types and/or quantities of compute resources, and the different types of workloads may consume those compute resources for different periods of time (e.g., the consumed compute resources may be unavailable for performance of other workloads during the different periods of time). In order to increase the likelihood of efficient use of the compute resources and efficient performance of the workloads, the compute resources may be managed according to workload requirements. For example, a workload may be assigned to a portion of the compute resources based on the workload requirements and/or may be executed by the portion of the compute resources based on a schedule.

However, due to large volumes of workloads and/or complicated networks of limited compute resources, assigning a workload to a portion of the compute resources for execution based on a time of submission of the workload and/or at random may result in inefficient use of the compute resources and/or inefficient (e.g., untimely) performance of the workload. These inefficiencies may lead to unnecessary energy consumption, increased costs of maintaining the computing system, increased interruptions to and/or reductions in quality of computer-implemented services, etc. Thus, to increase the efficiency of workload performance and compute resource use, workload assignment and execution may be managed proactively based on the inference model lifecycle.

Additionally, any of the workloads may have some degree of time dependence. In other words, the quantity of compute resources required to perform a workload may vary over time. If such quantities of compute resources are unavailable to perform the workloads, then completion of the workloads may be delayed. Such delays may cause undesired downstream impacts. For example, workload performance delays may cause other workloads to be delayed (e.g., one workload may consume an output of another workload), cause agreements (e.g., service level agreements) to be violated, etc.

In general, embodiments disclosed herein may provide methods, systems, and/or devices for managing performance of inference model workloads by compute resources. To do so, resource consumption profiles may be obtained for the workloads. The resource consumption profiles may indicate predicted quantities and/or types of the compute resources that will be consumed over time in order to complete the workloads. Compute resource consumption for the inference model workloads may be predicted, in part, based on an inference model lifecycle. By doing so, workload placement (e.g., assignment and/or execution) may be planned proactively to increase the likelihood of efficient and/or timely workload performance and improved efficiency of use of the compute resources. Further, the system may be more likely to be able to provide and/or facilitate the desired computer-implemented services (e.g., that are provided timely).

To provide the above-mentioned functionality, the system of FIG. 1 may include data processing systems 102 and/or management system 104. Data processing systems 102, management system 104, and/or any other type of devices not shown in FIG. 1 may perform all, or a portion of the computer-implemented services independently and/or cooperatively.

Management system 104 may provide workload management services. The workload management services may facilitate management of workloads in a manner that improves resources use efficiency and/or timeliness of completion of the workloads. To provide the workload management services, management system 104 may (i) identify a workload to be performed (e.g., a workload that facilitates operation of an inference model), (ii) identify a type of the workload (e.g., based on a lifecycle phase of the inference model), (iii) obtain a resource consumption profile for the workload (e.g., based on the type of the workload), (iv) identify target compute resources to perform the workload timely (e.g., based on the resource consumption profile), (v) initiate performance of the workload (e.g., by the target compute resources) to obtain a workload result, (vi) initiate provision of a computer-implemented service using the workload result (e.g., using an improved inference model to provide inferencing services), and/or (vii) perform other actions relating to the management of inference models, workloads, and/or compute resources.

While providing its functionality, management system 104 may communicate with data processing systems 102. For example, data processing systems 102 may include functionality for reporting use of its compute resources, and management system 104 may obtain resource availability data from data processing systems 102. Management system 104 may use the resource availability data to place (e.g., assign and/or schedule) workloads to data processing system 102 (e.g., to identify target compute resources usable to perform the workloads timely). The workloads may include tasks, processes, and/or data transactions that facilitate operation of inference models managed by management system 104. Refer to FIG. 2B for more information regarding workload placement based on the inference model lifecycle.

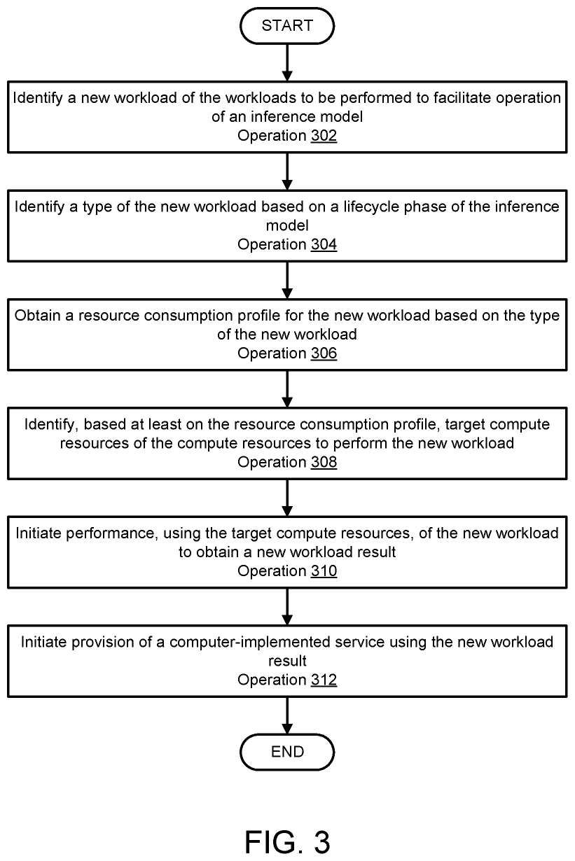

When providing their functionality, any of data processing systems 102 and/or management system 104 may perform all, or a portion of the method shown in FIG. 3.

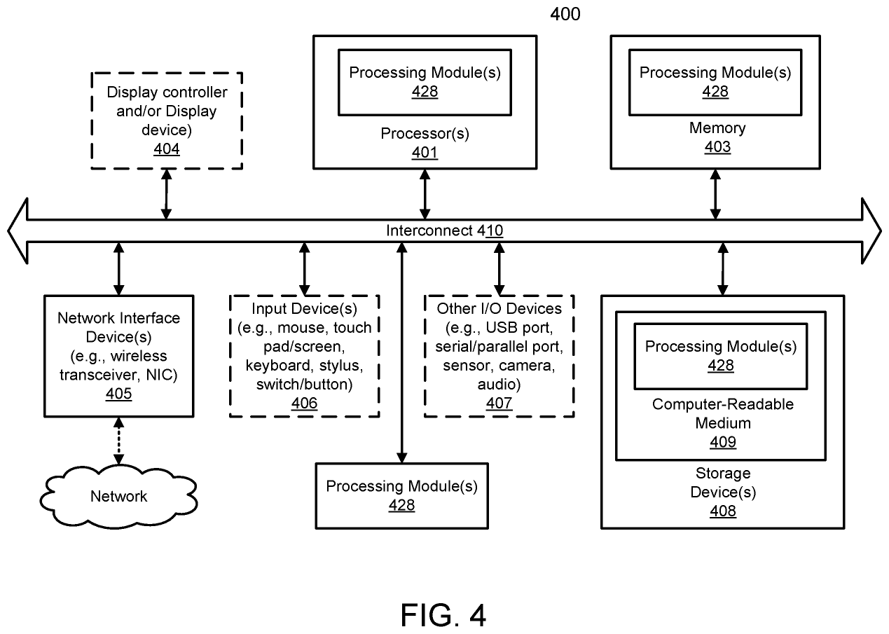

Any of (and/or components thereof) data processing systems 102, and/or management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

In an embodiment, one or more of data processing systems 102 and/or management system 104 are implemented using an IoT device, which may include a computing device. The IoT device may operate in accordance with a communication model and/or management model known to data processing systems 102, management system 104, and/or other devices.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and/or types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows implemented by a system over time in accordance with an embodiment are shown in FIGS. 2A-2B. In these diagrams, flows of data and processing of data are illustrated using different sets of shapes. A first set of shapes (e.g., 202, 204) is used to represent data structures, a second set of shapes (e.g., 206, 210, etc.) is used to represent processes performed using data, a third set of shapes (e.g., 208) is used to represent large scale data structures such as databases, and a fourth set of shapes (e.g., 102A, 102N) is used to represent special purpose hardware components (e.g., of compute resources).

The processes shown in FIGS. 2A-2B may be performed by any entity shown in the system of FIG. 1 (e.g., any data processing system(s) similar to data processing systems 102, a management system similar to management system 104) and/or another entity without departing from embodiments disclosed herein.

Turning to FIG. 2A, a first data flow diagram in accordance with an embodiment is shown. The first data flow diagram may illustrate data used in and data processing performed in facilitating operation of an inference model throughout various lifecycle phases. In the example shown in FIG. 2A, the lifecycle phases for the inference model may include modification phases 200 and/or inferencing phase 201. Modification phases 200 may include, for example, training of the inference model, retraining of the inference model, and/or fine-tuning of the inference model. Inferencing phase 201 may include, for example, inferencing using the inference model.

Other lifecycle phases may include testing or validation phases for the inference models, and/or any other lifecycle phases not shown in FIG. 2A. During different lifecycle phases, different workloads may be performed by portions of compute resources (e.g., of data processing systems 102) to facilitate operation of the inference model. For example, while an inference model is in a training phase of the lifecycle, a training workload may be performed. The training workload may include, for example, any processes, data transactions, and/or computations that may be performed by compute resources in order to obtain a trained inference model.

During modification phases 200, a management entity (e.g., management system 104) may facilitate performance of training process 206. Training process 206 may include training an (untrained) inference model defined by model data 202. Model data 202 may include information regarding architecture, hyperparameters, and/or other information regarding an inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. The inference models may, for example, be implemented with artificial neural networks, decision trees, regression analysis, and/or any other type of model usable for learning purposes.

Training process 206 may include obtaining an untrained inference model (not shown). The untrained inference model may be obtained based on model constraints defined by model data 202. The untrained inference model may be trained during training process 206 using training data 204.

Training data 204 may be obtained from any number of data sources (not shown). Over time, training data 204 may be updated (e.g., new training data may be added and/or existing training data may be removed or modified). For example, training data 204 may be curated based on the needs of training process 206 (e.g., to perform fine-tuning and/or retraining of an inference model, discussed later). In other words, training data 204 may include dynamic training data and/or portions of static training data.

Training data 204 may include data that defines an association between two pieces of information (e.g., a sample input associated with a sample output, the pair being labeled data). For example, training process 206 may employ supervised learning to train an inference model to associate a desired output sample of the training data with an input sample of the training data. Large numbers of associations may be trained into the inference model (e.g., using various combinations of input samples and output samples from the training data).

While the inference model is being trained, the inference model parameters may be updated based on associations specified by training data 204. For example, depending on the type of inference model being trained, values of model parameters such as coefficient, weight, bias, and/or cluster centroid values of the inference model may be updated. Training process 206 may include obtaining any number of different types and/or sizes of inference models.

To manage the (trained) inference models, trained inference model data may be stored in trained model repository 208. For example, the trained inference model data may include inference model data (e.g., information regarding the architecture and/or hyperparameters of the inference model) and/or model parameter values of the inference models (e.g., weights, biases). Trained model repository 208 may store and/or provide access to any number of inference models (e.g., trained model data). For example, trained model repository 208 may provide trained inference model data to training process 206 (e.g., for retraining and/or fine-tuning) and/or inferencing process 210 (e.g., for inference generation).

Training process 206 may include retraining and/or fine-tuning any number of inference models. For example, an existing inference model trained to perform an original task may be retrained or fine-tuned in order to perform a new task (e.g., depending on the similarity of the new task to the original task, the size and characteristics of the new dataset, and the type and/or quantity of compute resources available). Or, for example, an existing inference model may undergo re-training and/or fine-tuning when a measure of inference quality has fallen below an acceptable threshold (e.g., inference accuracy) and the existing inference model may require updating to improve its inference quality. To do so, training process 206 may include obtaining trained inference model data (for the existing inference model) stored in trained model repository 208.

For example, fine-tuning (or transfer learning) may be preferred when the new task is closely related to the original task and/or when the new training dataset is relatively small. On the other hand, for example, retraining may be preferred when the new task is substantially different from the original task, and there is a large volume of training data available. Retraining may include, for example, allowing updates to all parameters of the inference model, while fine-tuning the inference model may include retraining only a portion (e.g., a single layer) of the inference model. Therefore, in some cases fine-tuning the inference model may require less compute resources than retraining the inference model.

Thus, during modification phases 200, various portions of compute resources may perform workloads for obtaining untrained inference models, trained inference models, fine-tuned inference models, retrained inference models, and/or information regarding the inference models (e.g., performance statistics for the inference models). Once an inference model has undergone training process 206, the inference model may be able to predict a desired output from sample input not included in the training data (e.g., within an acceptable accuracy threshold). The trained model data (e.g., updated model data) may be provided to trained model repository 208 and/or may be used during an inferencing phase (e.g., 204).

During inferencing phase 201, trained model repository 208 may provide access to trained model data to facilitate inferencing process 210. An inference model may be obtained based on parameter constraints and/or values (e.g., node information, weight information, connection information, activation functions, etc.) included in the trained model data. Inferencing process 210 may include generating inferences based on ingest data 224.

Ingest data 212 may include a portion of data for which an inference is desired to be obtained. For example, ingest data 212 may be obtained from downstream consumers of the inferences (e.g., downstream consumers 214) and/or other data sources (not shown). Ingest data 212 may not include labeled data and, thus, an association for ingest data 212 may not be known. For example, inferencing process 210 may include using ingest data 212 as input to the inference model in order to predict an output associated with the input (e.g., generate an inference). Inferencing process 210 may include providing the inference to downstream consumers 214 as a computer-implemented service.

Thus, during inferencing phase 201, various portions of compute resources may perform workloads for inferencing using inference models, provide inferences to downstream consumers, and/or obtain other information regarding the inference model and/or information regarding inferences (e.g., measurements of inference accuracy or quality) generated by the inference model.

Movement of an inference model throughout the inference model lifecycle may be predicted. For example, an inference model in a fine-tuning phase may be likely to enter an inferencing phase once the fine-tuning phase is complete. Or, for example, inference accuracy and/or quality measurements for inferences generated by an inference model in an inferencing phase may be likely to enter a retraining phase. Therefore, the movement of inference models throughout the inference model lifecycle may be monitored and/or predicted (e.g., by a management entity) in order to predict future workload demands.

The workloads performed to move the inference models through the lifecycle may be classified by workload type. A workload type may, for example, include tasks (e.g., computational tasks and/or other tasks for performing processes and/or data transactions) that may relate to managing the inference model during a particular lifecycle phase. For example, a training workload for an inference model in a training phase may include a higher number of data transaction tasks (e.g., for reading and/or processing large volumes of training data) than an inferencing workload for an inference model in an inferencing phase.

Thus, as the inference models move through different lifecycle phases (e.g., to complete workloads associated with each of the different lifecycle phases), different types and/or quantities of compute resources may be required to perform each of the workloads timely. For example, a workload with a large number of data transaction tasks may be performed more efficiently when executed by a portion of compute resources with high-speed interconnections, whereas a workload with a large number of computational tasks may be performed most efficiently when the computational tasks are able to be executed in parallel (e.g., by a graphics processing unit (GPU) or other specialized hardware). Therefore, when assigning a workload for an inference model to a portion of compute resources for execution, the lifecycle phase of the inference model may be considered by a system in accordance with an embodiment.

Thus, as illustrated by the data flows shown in FIG. 2A, the system of FIG. 1 may facilitate operation of inference models through different phases of the inference model lifecycle. The different lifecycle phases may be associated with different types of workloads (e.g., inferencing workloads, training workloads, fine-tuning workloads, etc.). Each workload type may require different types and/or quantities of compute resources in order to be performed timely and/or efficiently. In addition, workload generation may be predicted based on the inference model lifecycle. Therefore, these compute resource requirements may be predicted based on the inference model lifecycle and may be used to improve management of inference model workloads.

Turning to FIG. 2B, a second data flow diagram in accordance with an embodiment is shown. The second data flow diagram may illustrate data used in and data processing performed in managing workloads (e.g., inference model workloads).

To manage the workloads, resource consumption prediction process 254 may be performed. During resource consumption prediction process 254, (i) workloads queued for performance may be identified, and (ii) each identified workload may be analyzed to obtain a resource consumption profile for the workload. By doing so, the resource consumption profiles may be used to select data processing systems that are more likely to have sufficient available quantities of computing resources to complete the workload timely.

The workloads may be performed by compute resources of the selected data processing systems, for example, to facilitate inference model generation, maintenance, improvement, repurposing, and/or implementation via processes such as training, retraining, fine-tuning, transfer learning, inference generation, etc. In order to manage performance of the workloads efficiently, resource requirements for inference model workloads may be predicted and planned for based on the inference model lifecycle.

In the example shown, workload 252 may be identified. Workload 252 may include tasks that relate to managing an inference model while an inference model is in a lifecycle phase. Workload 252 may also include information regarding the inference model (e.g., identifiers usable to obtain relevant model data from a trained model repository, characteristics of the inference model). The tasks of workload 252 may be performed by a portion of compute resources of a computing system (e.g., a distributed computing system made up of data processing systems 102). To identify the portion of compute resources for performing workload 252, workload 252 may be provided to resource consumption prediction process 254.

Resource consumption prediction process 254 may estimate the quantity of resources (e.g., over time) that workloads are likely to consume. To identify the quantity of resources, workloads may be analyzed during resource consumption prediction process 254, including workload 252. During resource consumption prediction process 254, a type of workload may be identified for workload 252. The workload type may be one of multiple workload types that may include, for example, a training workload, a retraining workload, an inferencing workload, etc., and may therefore be based on the current lifecycle phase of the inference model. Resource consumption prediction process 254 may include predicting compute resource requirements for performing workload 252 timely.

The quantity and/or type of compute resources that may be consumed over time while performing workload 252 may depend on the workload type and/or characteristics of the inference model. For example, the characteristics of the inference model may include the model type (e.g., whether the inference model ingests text-based data and/or image-based data), the complexity of the model (e.g., the number of hyperparameters, layers), and/or the size of the inference model.

During resource consumption prediction process 254, a resource consumption profile for workload 252 may be obtained (e.g., generated). The resource consumption profile may specify predicted quantities (and types) of the compute resources that will be consumed to perform each task of the tasks included in the workload. The predicted quantities (and types) of the compute resources may be specified for durations of time over which the tasks will be performed (and over which the compute resources may be unavailable to perform tasks of other workloads). Resource consumption prediction process 254 may include making the resource consumption profile available to other processes, such as workload assignment process 256.

Once a resource consumption profile for workload 252 is obtained, workload assignment process 256 may be performed. Workload assignment process 256 may use the resource consumption profile of workload 252 to identify target compute resources of data processing systems 102 sufficient to perform workload 252. The target compute resources may include any portion of the compute resources (e.g., any portion of any number of nodes included in the computing system) sufficient for performing workload 252 timely and/or efficiently (e.g., with respect to other workloads that may be in queue for performance).

For example, to identify the target compute resources, workload assignment process 256 may include screening the compute resources to identify portions (e.g., subsets) of the compute resources sufficient for performing workload 252 timely according to the resource consumption profile. For each identified subset of the compute resources, workload assignment process 256 may obtain resource availability information. The resource availability information may be obtained from the data processing systems 102. To obtain the resource availability information, workload assignment process 256 may include fetching (e.g., requesting) resource availability reports from any of data processing systems 102. Alternatively, any of data processing systems 102 may include a self-reporting resource availability function that may report the resource availability to the management entity and/or other systems.

The resource availability information may include any number of resource consumption profiles for any number of workloads assigned to (e.g., for current and/or future execution by) each identified subset of the compute resources. Therefore, the resource availability information may be used to identify a quantity of available compute resources. For example, the quantity of available compute resources may be indicated by a time series usable to identify current and/or future periods of time when each subset of the compute resources is able to perform workload 252 timely.

Workload assignment process 256 may include making a determination whether each a subset of the compute resources has sufficient availability for performing workload 252 timely. If a subset of the compute resources has sufficient availability, then the subset of the compute resources may be qualified to perform at least a portion of workload 252. That is, workload assignment process 256 may include portioning workload 252 into sub-portions (e.g., groups of tasks). For example, workload 252 may be split into sub-portions (e.g., a heavy workload and a light workload) that may be performed at different times and/or by different portions of the compute resources in order to balance compute resource use of data processing systems 102 over time.

Once workload assignment process 256 has completed screening the compute resources, the qualified subsets may be analyzed (e.g., rank ordered) based on additional resource characteristics. For example, resource characteristics may include historical error/failure rate, connection speed and/or reliability, etc. Workload assignment process 256 may identify the target compute resources based on the analysis (e.g., a rank ordering) of the qualified subsets. The target compute resources may include a portion of the compute resources most likely to perform workload 252 and/or other workloads efficiently and timely.

Thus, workload assignment process 256 may use predicted resource consumption profiles and/or other criteria (e.g., priority levels of workload 252 and/or other workloads) to identify target compute resources for performing workload 252 timely. Workload assignment process 256 may include obtaining assignment information. The assignment information may include an identifier for the target compute resources, an execution time for workload 252, and/or other information. For example, the assignment information may specify that workload 252 is to be assigned to a workload queue for the target compute resources, where workload 252 will be executed after other workloads in the workload queue have completed. The assignment information may be made available to data processing systems 102 and/or other systems.

Data processing systems 102 may obtain workload 252 and its corresponding assignment information, and data processing systems 102 may perform workload 252 in accordance with the assignment information.

Thus, as illustrated in FIG. 2B, the system of FIG. 1 may predict resource consumption profiles for inference model workloads based on a lifecycle phase of the inference model. The predicted resource consumption profiles may be used to identify target compute resources that are more likely to perform the inference model workloads timely and efficiently. By predicting resource consumption based on the inference model lifecycle, compute resource scheduling and/or planning may be performed proactively, reducing the likelihood of that the compute resources are used inefficiently over time.

In FIGS. 2A-2B, any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage workload performance. FIG. 3 illustrates a method that may be performed by the components of FIG. 1. In the diagram discussed below and shown in FIG. 3, any of the operations may be repeated, performed in different orders, and/or performed in parallel with or in a partially overlapping in time manner with other operations. The methods may be performed by a data processing system (e.g., of data processing systems 102), a management system (e.g., 104), and/or another device.

Turning to FIG. 3, a flow diagram illustrating a method in accordance with an embodiment is shown. The flow diagram may illustrate various operations performed while managing performance of workloads (e.g., inference model workloads) by compute resources. The compute resources may be part of a computing system. In order to perform the workloads, the workloads may be placed on the computing system (e.g., the workloads may be assigned to portions of the compute resources of the computing system and/or may be scheduled) for execution.

At operation 302, a new workload of the workloads to be performed to facilitate operation of an inference model may be identified. The new workload may be identified by (i) receiving a message (e.g., from another entity) regarding the new workload, (ii) reading the message (e.g., from storage) a message regarding placement of the new workload, and/or (iii) by other methods. The message may include identifiers for the new workload, identifiers for the inference model, and/or other information. The message may indicate that the new workload for the inference model has been generated for placement on the computing system.

The new workload may include tasks relating to managing the inference model while the inference model is in the lifecycle phase. For example, the new workload may include tasks relating to training the inference model, inferencing using the inference model, receiving and/or transmitting data, etc.

At operation 304, a type of the new workload may be identified based on a lifecycle phase of the inference model. The type of the new workload may be identified by (i) identifying the inference model (e.g., by reading information included in the message, by analyzing the new workload (e.g., reading its metadata), (ii) querying a management entity of the inference model to identify a (current) lifecycle phase of the inference model, and (iii) selecting the type of the workload that may correspond to the lifecycle phase. For example, if the inference model is in training phase, an inferencing phase, a fine-tuning phase, a retraining phase, and/or any other lifecycle phase, then the type of the new workload may include a training workload, an inferencing workload, a fine-tuning workload, a retraining workload, and/or any other type of workload, respectively. The inference models may self-report their current lifecycle phase, information regarding changes in lifecycle phases may be recorded over time, and/or other tracking mechanisms may be used to identify the lifecycle phase of the inference model without departing from embodiments disclosed herein.

At operation 306, a resource consumption profile for the new workload may be obtained based on the type of the new workload. The resource consumption profile may be obtained by performing a resource consumption prediction process (e.g., 254 of FIG. 2B). For example, the resource consumption profile may be obtained by (i) identifying characteristics of the inference model (e.g., model type, model size) and (ii) predicting the resource consumption over time based on the characteristics of the inference model, the type of the workload, and/or other factors. For example, the resource consumption profile may be predicted using a function of variables (e.g., new workload tasks, characteristics of the inference model, training dataset size, inference dataset size).

The resource consumption profile may specify predicted quantities of the compute resources that will be consumed to perform each task of the tasks included in the workload. For example, the resource consumption profile may specify types of and/or minimum (or maximum) quantities of memory, storage, processing speed, data transfer speed (e.g., measures of latency, throughput), etc. The predicted quantities of the compute resources may be specified for durations of time over which the tasks may be performed. For example, as different tasks of the new workload are initiated and completed (e.g., some tasks may be performed sequentially or in parallel), the quantities of the compute resources that may be consumed may vary task by task and may therefore be presented as a time series.

At operation 308, target compute resources of the compute resources may be identified, based at least on the resource consumption profile. The target compute resources may be identified by performing a workload assignment process (e.g., 256 of FIG. 2B). For example, the target compute resources may be identified by (i) reading the resource consumption profile to obtain type of and/or a sufficient quantity of (the type of) compute resources for the new workload to be performed timely, and/or (ii) screening the compute resources (of the computing system) to identify a subset of the compute resources that includes the sufficient quantity of (the type of) compute resources.

For example, the resource consumption profile may include a type of compute resource required (e.g., preferred) to complete the new workload timely. Screening the compute resources may include interrogating a list of compute resource types and corresponding maximum compute resource capacities of the compute resource types to identify the subset. The identified subset may include a maximum compute resource capacity equal to or greater than the sufficient quantity of compute resources specified by the resource consumption profile.

Any number of subsets with sufficient compute resources for performing the new workload timely may be identified. The identified subset(s) may be listed in a list of subsets. For example, the list of subsets may include identifiers (e.g., hardware identifiers) for compute resources of the subset(s), a type of compute resources, the maximum compute resource capacities, and/or other information.

Identifying the target compute resources may include, for each identified subset of the compute resources, (i) identifying at least one workload of the workloads assigned to the subset for performance, (ii) identifying a second resource consumption profile for the at least one workload, and/or (iii) identifying a quantity of available compute resources of the subset based on the second resource consumption profile. For example, identifying the at least one workload may include obtaining (e.g., reading) resource availability information for the subset from the computing system (e.g., using identifiers from the list of subsets). The resource availability information may include workload identifiers for current and/or future workloads assigned to the subset (e.g., including the at least one workload).

Identifying the second resource consumption profile may include using the workload identifier to obtain the second resource consumption profile from the resource availability information and/or another source. The quantity of the available compute resources of the subset may be identified by analyzing the second resource consumption profile. The quantity of the available compute resources may be available based on a time series of the resource consumption profile to identify future periods of time when the subset is able to perform the new workload timely. For example, the quantity of the available compute resources may be identified by comparing current and/or future resource consumption for the subset to the maximum compute resource capacity of the subset.

When a subset with a sufficient quantity of available resources has been identified, the subset may be qualified to perform the new workload. Any number of subsets may be qualified to perform the new workload (e.g., the qualified subsets may be considered candidates for the target resources). The target compute resources may be identified by selecting one of the qualified subsets, for example, based on additional criteria. Identifying the target resources may include generating assignment information indicating that the target compute resources may perform the new workload. Refer to workload assignment process 256 of FIG. 2B for more information.

At operation 310, performance of the new workload may be initiated to obtain a new workload result. Performance of the new workload may be initiated by providing the assignment information to the computing system. For example, a message including the assignment information and/or other information may be transmitted to the computing system. The new workload result may be obtained upon completion of performance of the new workload by the target resources. The new workload result may include an inference, an updated inference model (e.g., trained, retrained, fine-tuned), and/or other results relating to operation of the inference model.

At operation 312, provision of a computer-implemented service may be initiated using the new workload result. The provision of the computer-implemented service may be initiated by making a new workload result available to a downstream consumer of the new workload result. For example, if the new workload includes an updated inference model, then the updated inference model may be made available for inferencing services. Or, for example, if the new workload includes an inference, then the inference may be made available to a downstream consumer of the inference.

The method may end following operation 312.

Thus, as illustrated above, embodiments disclosed herein may provide systems and methods usable to manage performance of inference model workloads by compute resources by predicting resource consumption based on the inference model lifecycle. By doing so, the inference model workloads may be scheduled to the compute resources that increases the likelihood of timely performance of the inference model workloads as well as efficient use of the compute resources.

Thus, embodiments disclosed herein may provide an improved computing device that is able to increase the likelihood of providing desired computer-implemented services that rely on efficient operation of inference models. Accordingly, the disclosed process provides for both an embodiment in computing technology and an improved method for managing workload performance by compute resources.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing performance of workloads by compute resources, the method comprising:
identifying a new workload of the workloads to be performed to facilitate operation of an inference model;
identifying a type of the new workload based on a lifecycle phase of the inference model;
obtaining a resource consumption profile for the new workload based on the type of the new workload;
identifying, based at least on the resource consumption profile, target compute resources of the compute resources to perform the new workload;
initiating performance, using the target compute resources, of the new workload to obtain a new workload result; and
initiating provision of a computer-implemented service using the new workload result.

2. The method of claim 1, wherein the new workload comprises tasks relating to managing the inference model while the inference model is in the lifecycle phase.

3. The method of claim 2, wherein the resource consumption profile specifies predicted quantities of the compute resources that will be consumed to perform each task of the tasks.

4. The method of claim 3, wherein the predicted quantities of the compute resources are specified for durations of time over which the tasks will be performed.

5. The method of claim 1, further comprising:
screening, based on the resource consumption profile, the compute resources to identify a subset of the compute resources, the subset comprising a quantity of the compute resources sufficient for the new workload to be performed timely.

6. The method of claim 5, wherein identifying the target compute resources comprises:
for the subset of the compute resources:
identifying at least one workload of the workloads assigned to the subset for performance,
identifying a second resource consumption profile for the at least one workload,
identifying a quantity of available compute resources of the subset based on the second resource consumption profile, and
in an instance of the identifying where the quantity of the available compute resources is sufficient to perform at least a portion of the new workload timely:
qualifying the subset to perform the new workload.

7. The method of claim 6, wherein the quantity of the available compute resources is available based on a time series that is usable to identify future periods of time when the subset is able to perform the new workload timely.

8. The method of claim 1, wherein the lifecycle phase of the inference model is one phase of a group of phases consisting of:
training of the inference model;
inferencing using the inference model;
fine-tuning of the inference model; and
retraining of the inference model.

9. A non-transitory machine-readable medium having instructions stored therein, which when executed by a processor, cause the processor to perform operations for managing performance of workloads by compute resources, the operations comprising:
identifying a new workload of the workloads to be performed to facilitate operation of an inference model;
identifying a type of the new workload based on a lifecycle phase of the inference model;
obtaining a resource consumption profile for the new workload based on the type of the new workload;
identifying, based at least on the resource consumption profile, target compute resources of the compute resources to perform the new workload;
initiating performance, using the target compute resources, of the new workload to obtain a new workload result; and
initiating provision of a computer-implemented service using the new workload result.

10. The non-transitory machine-readable medium of claim 9, wherein the new workload comprises tasks relating to managing the inference model while the inference model is in the lifecycle phase.

11. The non-transitory machine-readable medium of claim 10, wherein the resource consumption profile specifies predicted quantities of the compute resources that will be consumed to perform each task of the tasks.

12. The non-transitory machine-readable medium of claim 11, wherein the predicted quantities of the compute resources are specified for durations of time over which the tasks will be performed.

13. The non-transitory machine-readable medium of claim 9, further comprising:
screening, based on the resource consumption profile, the compute resources to identify a subset of the compute resources, the subset comprising a quantity of the compute resources sufficient for the new workload to be performed timely.

14. The non-transitory machine-readable medium of claim 13, wherein identifying the target compute resources comprises:
for the subset of the compute resources:
identifying at least one workload of the workloads assigned to the subset for performance,
identifying a second resource consumption profile for the at least one workload,
identifying a quantity of available compute resources of subset based on the second resource consumption profile, and
in an instance of the identifying where the quantity of the available compute resources is sufficient to perform at least a portion of the new workload timely:
qualifying the subset to perform the new workload.

15. A data processing system, comprising:
a processor; and
a memory coupled to the processor to store instructions, which when executed by the processor, cause the processor to perform operations for managing performance of workloads by compute resources, the operations comprising:
identifying a new workload of the workloads to be performed to facilitate operation of an inference model,
identifying a type of the new workload based on a lifecycle phase of the inference model,
obtaining a resource consumption profile for the new workload based on the type of the new workload,
identifying, based at least on the resource consumption profile, target compute resources of the compute resources to perform the new workload,
initiating performance, using the target compute resources, of the new workload to obtain a new workload result, and
initiating provision of a computer-implemented service using the new workload result.

16. The data processing system of claim 15, wherein the new workload comprises tasks relating to managing the inference model while the inference model is in the lifecycle phase.

17. The data processing system of claim 16, wherein the resource consumption profile specifies predicted quantities of the compute resources that will be consumed to perform each task of the tasks.

18. The data processing system of claim 17, wherein the predicted quantities of the compute resources are specified for durations of time over which the tasks will be performed.

19. The data processing system of claim 15, further comprising:
screening, based on the resource consumption profile, the compute resources to identify a subset of the compute resources, the subset comprising a quantity of the compute resources sufficient for the new workload to be performed timely.

20. The data processing system of claim 19, wherein identifying the target compute resources comprises:
for the subset of the compute resources:
identifying at least one workload of the workloads assigned to the subset for performance,
identifying a second resource consumption profile for the at least one workload,
identifying a quantity of available compute resources of subset based on the second resource consumption profile, and
in an instance of the identifying where the quantity of the available compute resources is sufficient to perform at least a portion of the new workload timely:
qualifying the subset to perform the new workload.
